(19) United States
(12) Patent Application Publication
(10) Pub. No.: US 2006/0169917 A1
(43) Pub. Date: Aug. 3, 2006

(54) Silicone/graphite sample holder

(75) Inventor: Thomas Franz, Heidelberg (DE)

Correspondence Address: ROTHWELL, FIGG, ERNST & MANBECK, P.C., 1425 K STREET, N.W., SUITE 800, WASHINGTON, DC, 20005, US

(73) Assignee: Europaeisches Laboratorium Fuer Molekularbiologie (EMBL), Heidelberg (DE)

(21) Appl. No.: 10/542,601

(22) PCT Filed: Jan. 16, 2004
(86) PCT No.: PCT/EP04/00313

§ 371 Date: Mar. 3, 2006

(30) Foreign Application Priority Data
Jan. 17, 2003 (EP) 03001057.3

(51) Int. Cl. G01F 23/00

(52) U.S. Cl. 250/441.11

(57) ABSTRACT

The present invention relates to a sample holder for a mass spectrometer onto which a mixture of silicone and graphite is applied.

The present invention relates to a sample holder for a mass spectrometer onto which a mixture of silicone and graphite is applied.

The analysis of proteins by mass spectrometry has become a standard procedure in molecular biology in recent years. Peptide samples can be prepared by digestion of purified proteins directly or by an in-gel digestion of proteins previously separated by 1D or 2D-gel electrophoresis and mixed with a matrix for further analysis. A holder (target) is used onto which the samples are spotted. Presently, there are several robots available for spotting but for most applications manual spotting is necessary. Several types of holders exist. The most common one is a steel holder with ring shaped grooves. The samples are spotted into the ring, which is meant to prevent the samples from leaking out and cross-contaminating each other. Therefore, the volume that can be applied to that type of holder is fairly small and the crystals are very far apart. Additionally, the peptides bind only weakly to the steel surface and therefore the samples cannot be washed to get rid of surplus salt after spotting. This often results in poor data in the following mass spectrometric analysis. This makes the steel holder not feasible for automated procedures and limits the sensitivity of the analysis in general since only little sample solution can be applied on each spot.

Steel targets have the disadvantage that there is no on target washing for removing contaminating and signal suppressing salts possible.

Graphite targets cannot be regenerated, because of the strong absorption of the sample on the surface, which is also true for porous silicone targets. Besides this pure graphite targets have the disadvantage that the mass spectrometer can be easily contaminated by conductive graphite dust, which will lead to a breakdown of the turbo pumps or the electronic and therefore damage the instrument seriously. Same is true for the so-called liquid matrix, some graphite dispersed in a viscose solvent like glycerol or silicone oil.

Other holders try to circumvent the problem of sample spreading and small volumes by applying a hydrophobic material on the steel target only leaving a small not coated spot on which the sample concentrates after evaporation of the solvent (hydrophilic anchors).

A different approach uses a hydrophobic coating and a small spot filled with chromatographic reversed phase C-18 material on a steel target. The samples can then be washed to remove salt after they have been spotted onto the holder, which increases the quality of the mass spectrometry read-out later. However, because of the nature of the reversed phase material and the strong binding of the peptides to it, it is difficult to regenerate the material after use, which often leads to cross over contamination or loss of the chromatographic material during regeneration of the target.

Thus, one objective of the invention is to provide a sample holder with a surface to which the peptides bind strongly in order to allow washing of the samples on the holder and which at the same time can be entirely regenerated leaving no contaminants.

This objective was accomplished according to the invention by providing a sample holder for a mass spectrometer characterized in that it contains a coating comprising silicone and graphite.

The inventor has found that applying a thin (e.g. 0.01 to 2 mm, ideally 0.2 mm) layer comprising a mixture of commercially available silicone with 1 to 70 wt- %, ideally 10-30 wt- % graphite solves all the above-mentioned problems. The amount of graphite as well as the thickness of the coating can be adjusted according to the respective sample to be measured.

The silicone-graphite mix strongly binds peptides, allowing washes, increasing sensitivity, retaining the resolution and feasibility for automation, and is easily removed using conventional silicone removers.

Due to the good binding characteristics of the coating according to the invention, the sample can be applied to a smaller surface which leads to a higher concentration of the sample/surface sample holder and thus leads to better results in the mass spectrometry.

Any silicone can be used as a silicone component. Preferably, a silicone, which is commercially available, is used. Suitable silicones include any compounds in which Si atoms are connected to O atoms to form chain or net like structures and any remaining valences of Si are connected to hydrocarbon groups. Suitable hydrocarbon groups include C₁-C₈ alkyl groups, e.g. methyl, ethyl or propyl, C₂-C₈ alkenyl groups or C₄-C₁₅ aryl groups, e.g. phenyl. The hydrocarbon groups preferably contain 1 to 15, in particular 1 to 8 C-atoms and may contain one or more heteroatoms, e.g. selected from N, O or S.

The hydrocarbon groups may further comprise substituents, e.g. OH, NH₂, NO₂, COOH, C₁-C₄ alkoxy, halogens or COOR, with R being a C₁-C₈ hydrocarbon group.

A graphite powder is preferably used as graphite.

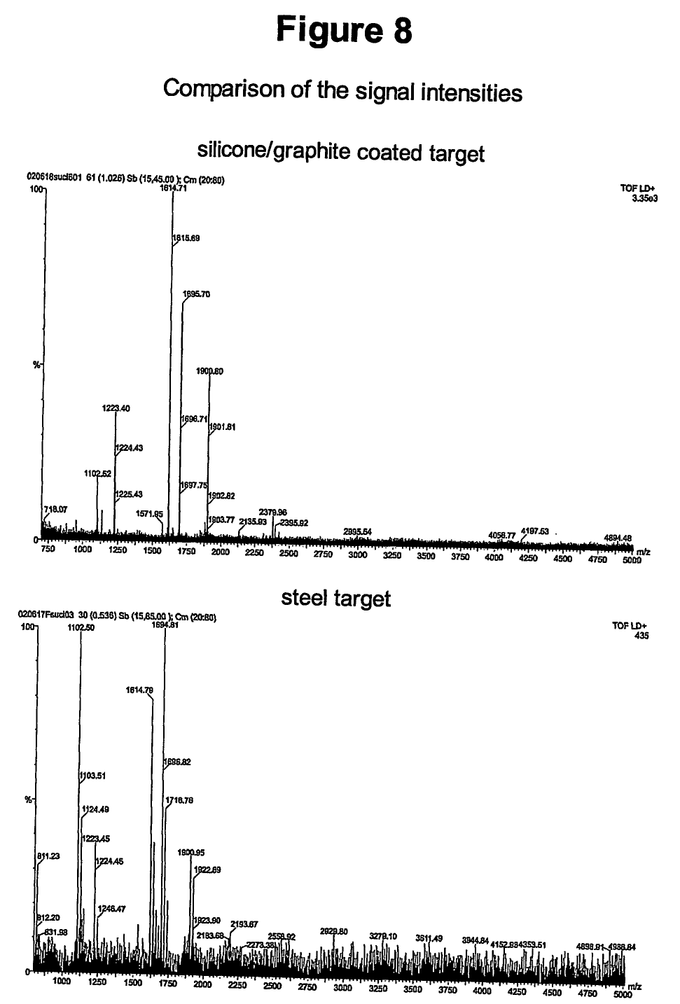

The manufacture of the coating according to the invention can be effected by mixing a silicone with graphite. This mixture can then be applied to a sample carrier. Preferably, monomers or prepolymers, which can react to a silicone, are first mixed with graphite, this mixture is applied to a sample carrier and then polymerized on the sample carrier. It is further possible to mix a sample with the graphite and/or silicone components and apply this sample/graphite/silicone mixture as coating to a sample holder. It is possible to add an additional matrix compound to enhance the MS performance, but spectra can also be obtained without the use of such additional matrix substances (cf. FIG. 8).

The sample holder itself can be made of any type of material, preferably of steel. Furthermore, the invention concerns the use of a mixture of silicone and graphite for coating a sample holder for a mass spectrometer.

Furthermore, the invention concerns a method of analyzing a sample in a mass spectrometer comprising the steps
(a) providing a sample holder containing a coating comprising silicone and graphite,
(b) applying the sample onto the sample holder and
(c) performing a mass spectrometry analysis of the sample.

A special advantage of the sample holder coating according to the invention consists in that the sample holder can be washed in order to remove contaminations from the sample, in particular salt contaminations. This is possible, because the sample strongly adheres to the coating that it is not being washed off and on the other hand since contaminations, especially salts, can be removed due to their water solubility. The washing step is preferably is carried out with water or aqueous solutions. The sample carrier and/or the method according to the invention is especially suitable in connection with the determination of biomolecules such as proteins, peptides, nucleic acids, steroids, fatty acids, sugars, small molecules (M_{W}<1000 Da), especially of proteins and/or peptides. For mass spectrometric analysis the sample applied to the sample holder is preferably subjected to a laser desorption step.

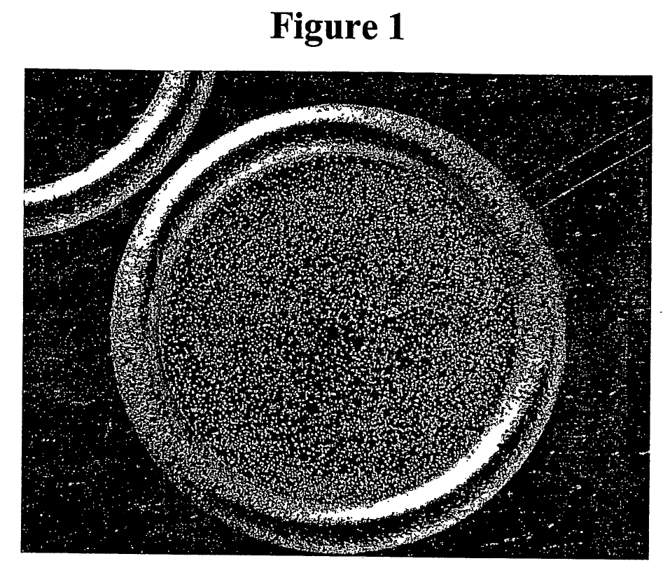

The invention is further explained by the enclosed Figures and the following examples. FIG. 1 shows a steel target with 2 μl spotted matrix/sample mix. The diameter of a spot is 2,5 mm (resulting in an area of 4,9 mm²).

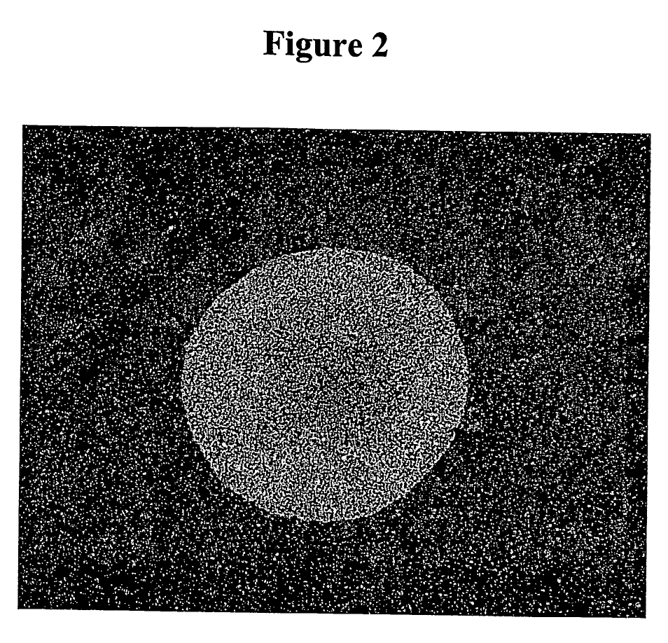

FIG. 2 shows a silicone/graphite target according to the invention with 2 μl spotted matrix/sample mix. The diameter is 1,9 mm (corresponding to an area of 2,8 mm²). Thus, the sample is concentrated on a 40% smaller area, which means that there is no search for a good spot on the target necessary. Firing the laser on the silicone-graphite target produces immediatelysignals, but in the case of the steel target it is most often necessary to search for good crystallized spots inside the target spot.

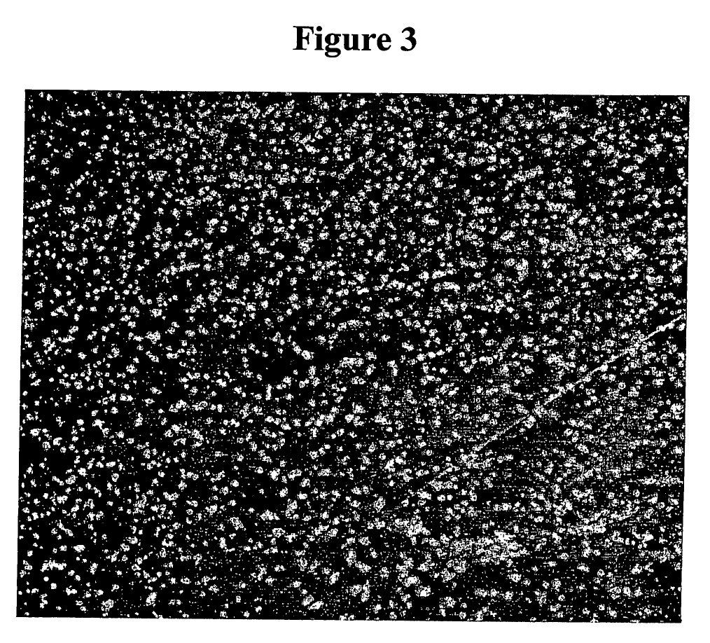

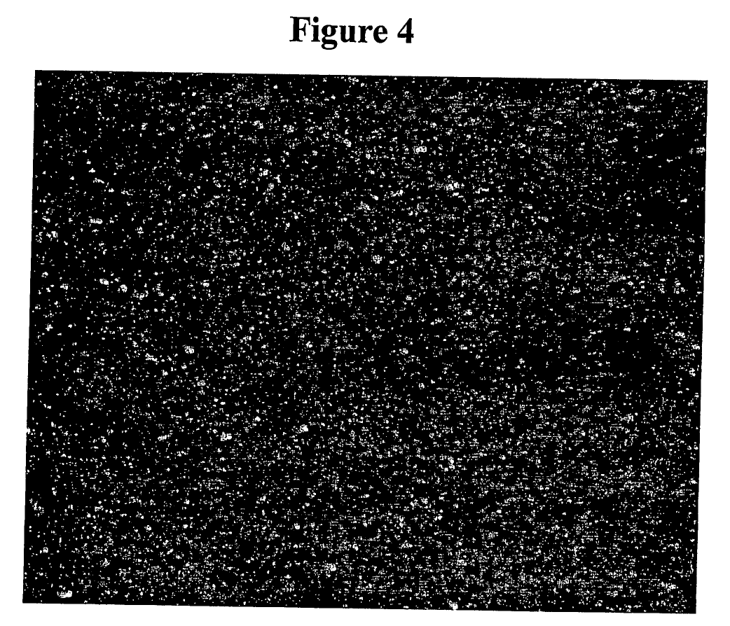

FIG. 3 shows in an enlargement the fairly wide distributions of the crystals of Matrix/sample on a steel target.

FIG. 4 shows the homogene crystallization of a sample on a silicone/graphite target.

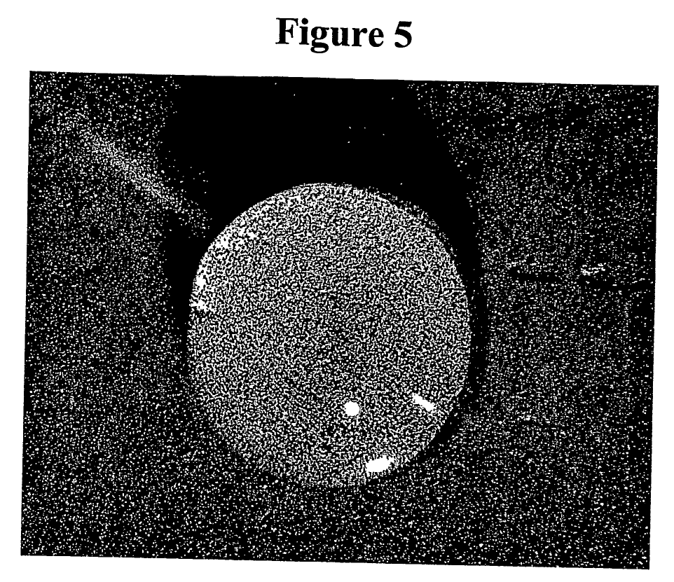

FIG. 5 shows a wash step performed on a silicone/graphite target according to the invention. Because of the relatively high hydrophobicity of the silicone/graphite coating, it is possible to wash such crystallized spots with large amounts of water. Usually, a drop of about 8 μl is set on the Matrix/sample spot. The water spot covers just the crystallization area and does not spread further. Because of the large amounts of water one washing step is sufficient since the contaminating salts are very effectively dissolved in the washing water.

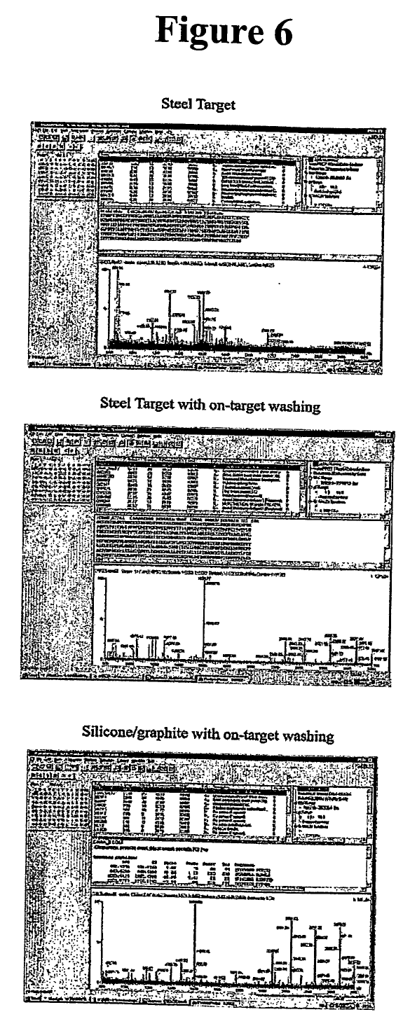

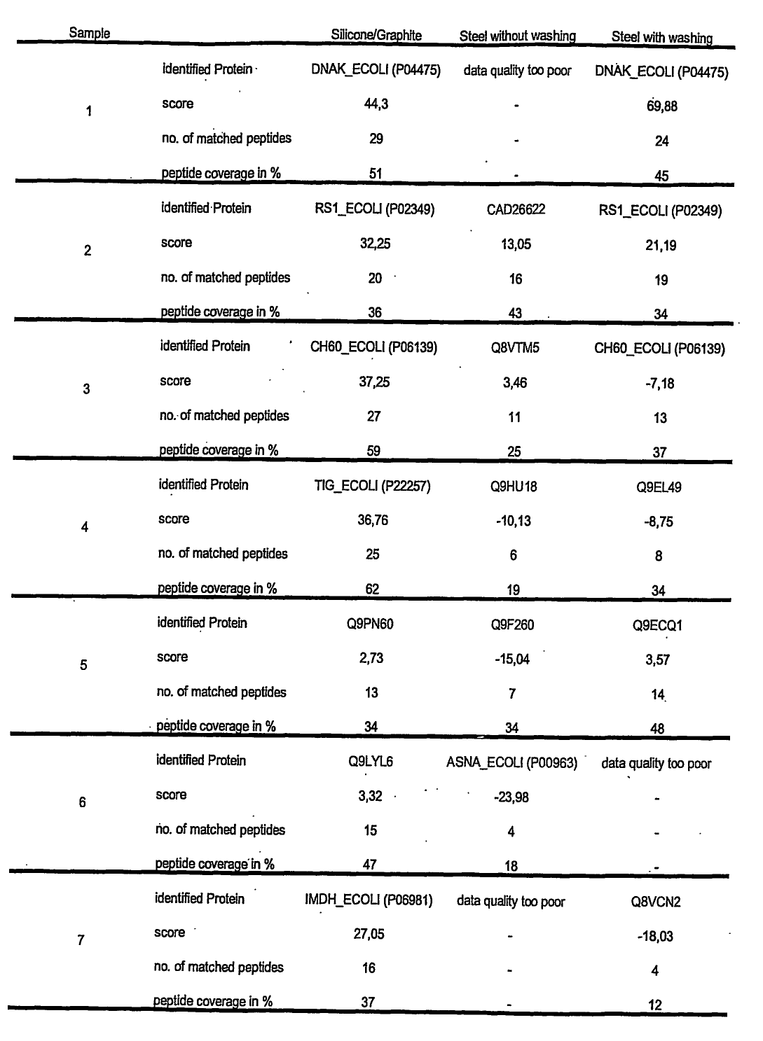

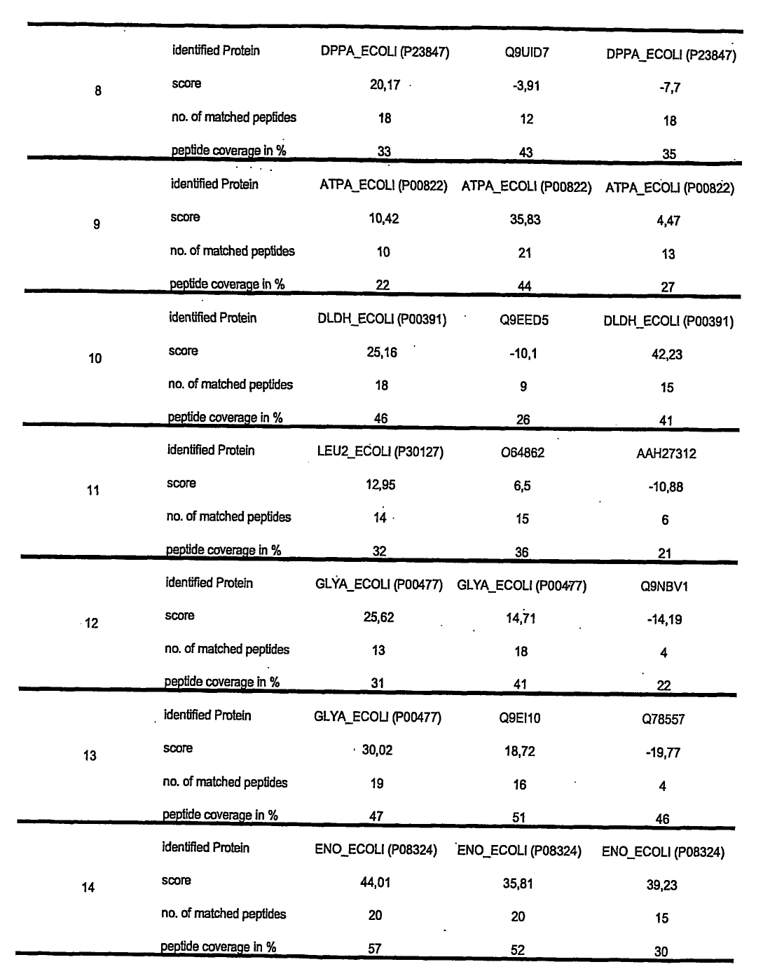

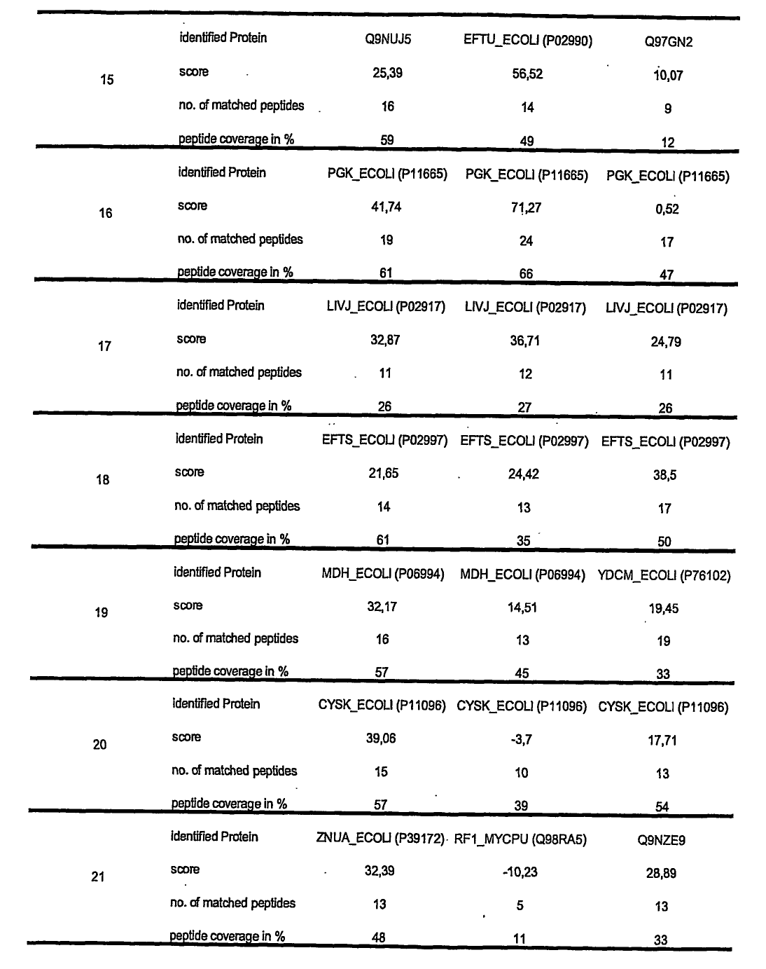

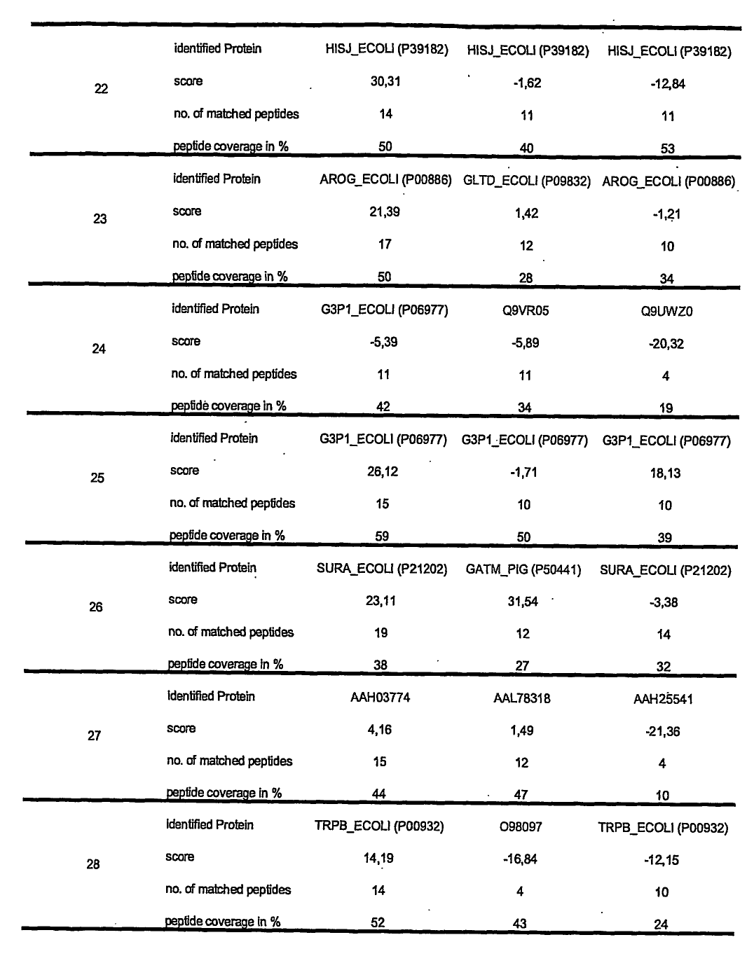

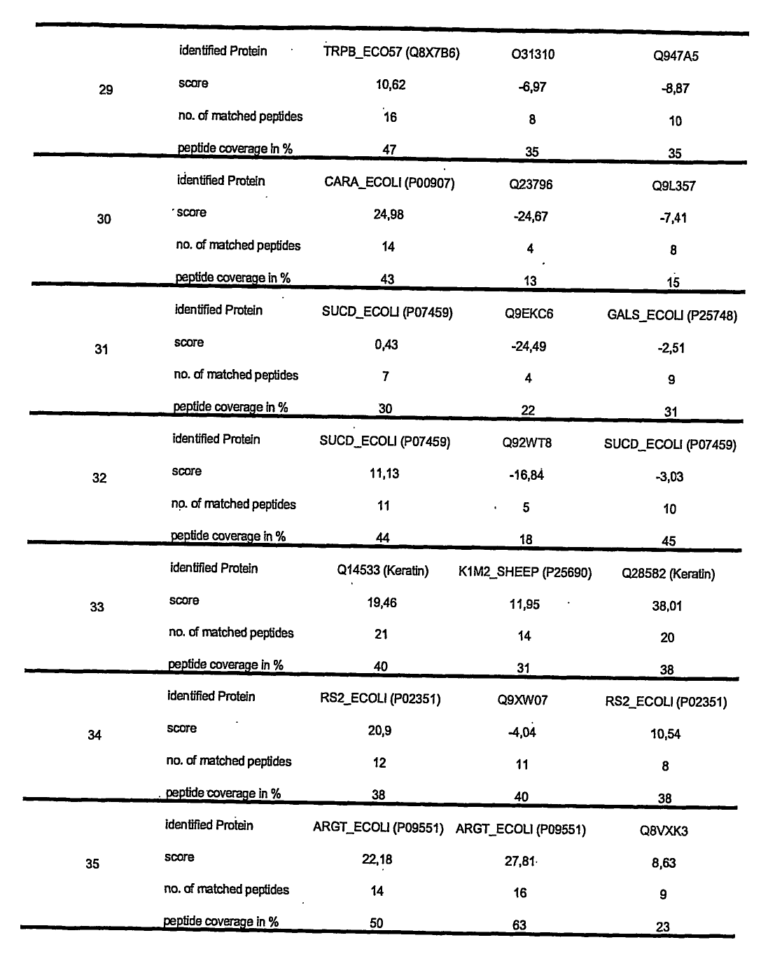

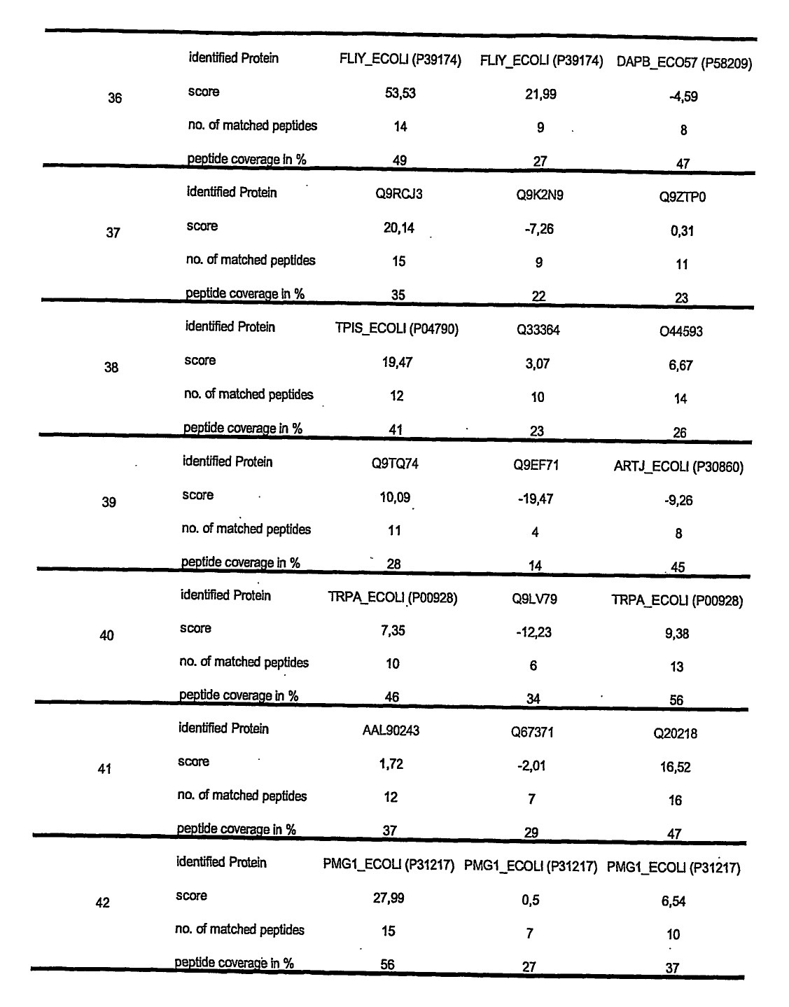

FIG. 6 shows the result of a comparison between steel and silicone/graphite targets of samples deriving from a 2D-gel separation and in gel tryptic digestion is shown below. The steel target without washing gave a positive database search identification result of 29% and after washing of the steel target 26%, but with the silicone/graphite coated target, including on-target washing, the positive identification was 79%. See row 1 to 7 (56 samples). Row number 8 was a control containing only extracts from blank gel, no proteins, therefore no positive identification. A list showing the identified proteins is also given.

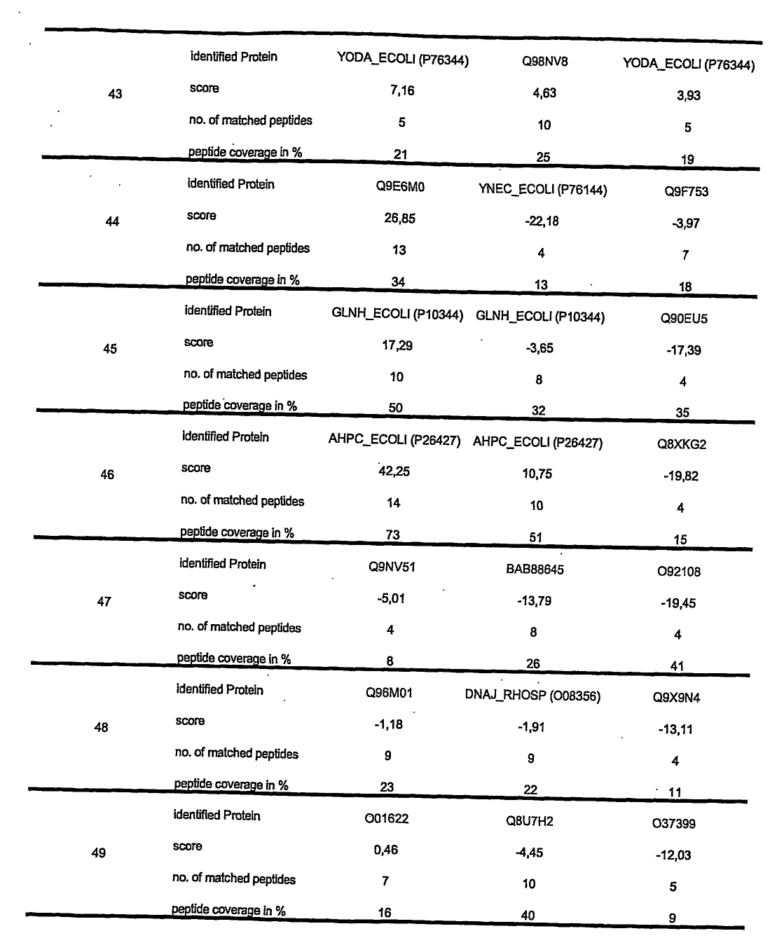

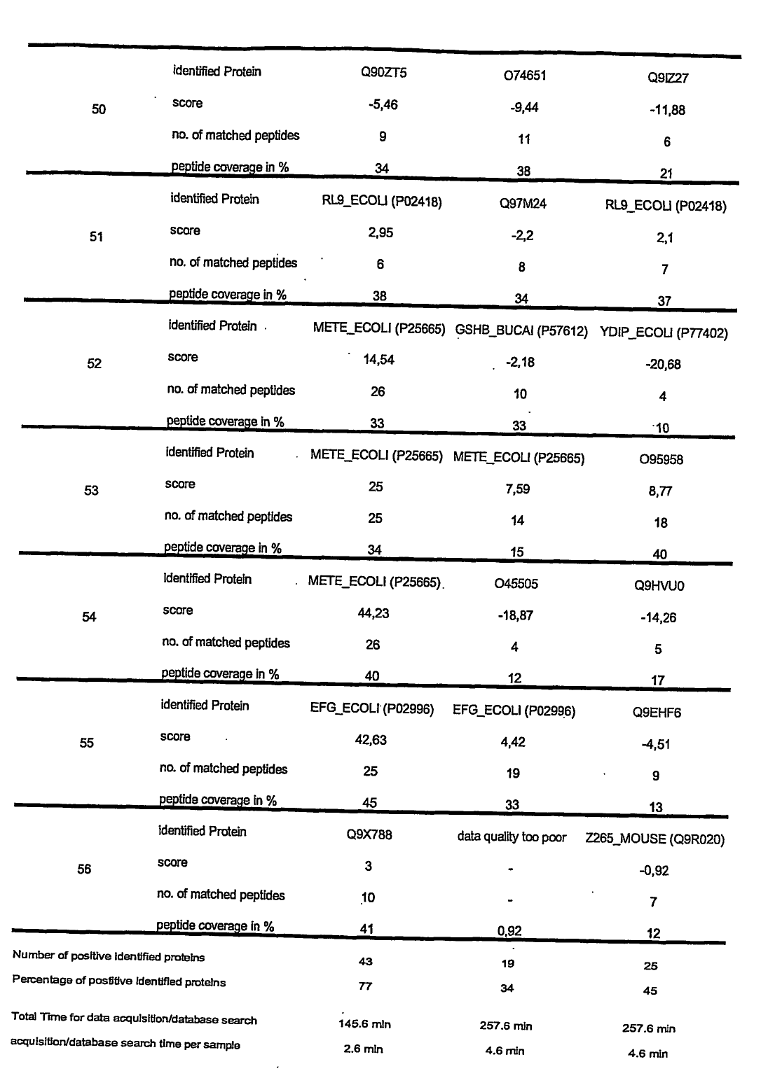

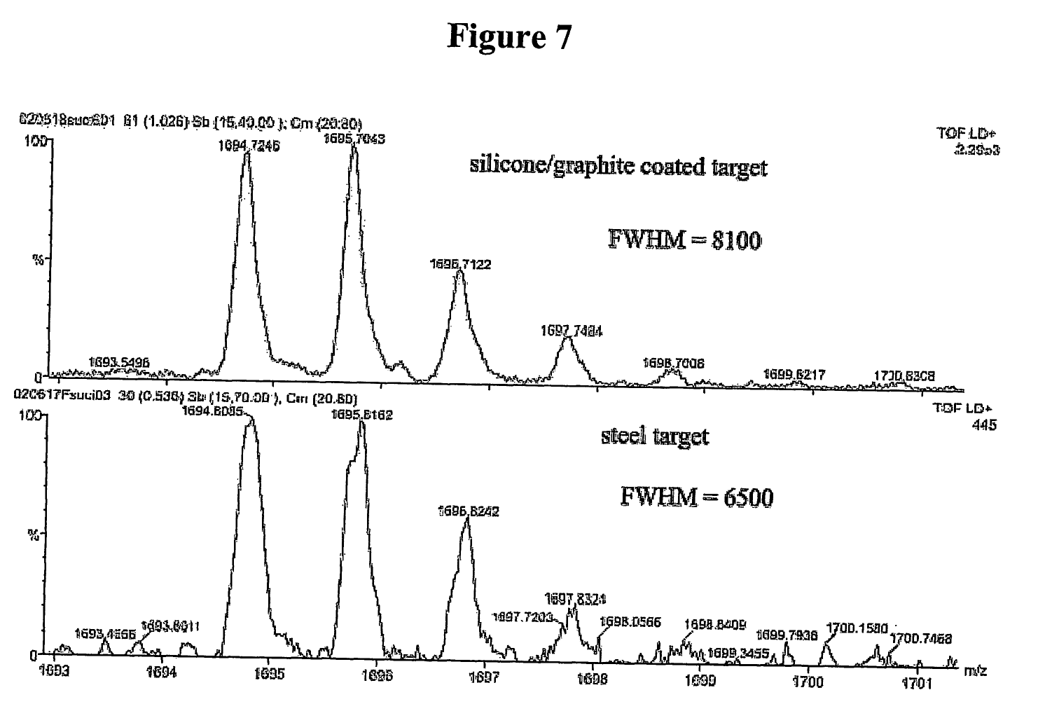

FIG. 7 shows mass spectra obtained using a silicone/graphite coated target according to the invention or a steel target. A comparison of resolution between the steel and silicone/graphite target showed that there are no significant differences (steel 6500 and slightly better silicone/graphite 8100) and therefore the silicone/graphite target is resolution neutral. Compraison of the intensity showed clearly that the silicone/graphite target (here 3350 total ion counts per second) is in average 4 times more sensitive than the steel target (in this example 445 total ion counts per second), which is very important for the analysis of less abundant proteins.

FIG. 8 shows a comparison of signal intensities. With the silicone/graphite matrix it is even possible to acquire spectra without using a matrix as shown in FIG. 8 where a mixture of 6 peptides was applied to the silicone/graphite coated target without additional matrix.

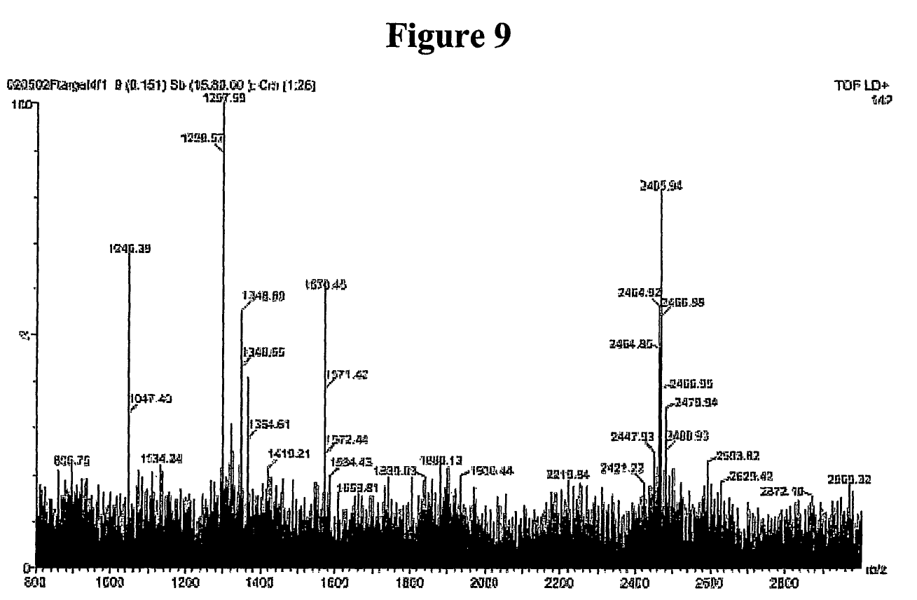

FIG. 9 shows that there are no background signals deriving from the silicone/graphite coating, which is an additional advantage.

### EXAMPLES

### Example 1

Materials

Silicone: “Knauf kitchen silicone acetat crosslinking (Knauf Bauprodukte GmbH, ID-Nr. 7949)
Graphite: Merck, Graphite, pulver, pure, Order No. 1.04206.2500

1.58 g silicone were thoroughly mixed with 0.185 g graphite and immediately transferred onto the MS steel target with the help of a spatula. The target was then pushed through a coating apparatus that produced a defined height of the silicone/graphite layer of 0.2 mm. The polymerisation process took over night.

With the help of a sample holder manufactured in that way, the results, which are shown in the Figures, were obtained and compared with a conventional steel target.

1. A sample holder for a mass spectrometer characterized in that it contains a coating comprising silicone and graphite.

2. Sample holder according to claim 1, wherein the coating layer having a thickness of 0,01 to 1 mm.

3. Sample holder according to claim 1, wherein the coating contains 1 parts by weight of graphite: 100 parts by weight silicone to 70 parts by weight graphite: 100 parts by weight silicone

4. Sample holder according to claim 3, wherein the coating contains 10 parts by weight graphite: 100 parts by weight silicone to 30 parts by weight graphite: 100 parts by weight silicone.

5. Sample holder according to claim 1, wherein the coating is prepared by polymerizing a silicone-forming monomer or prepolymer in the presence of graphite.

6. Use of silicone and graphite for coating a sample holder for a mass spectrometer.

7. A method of analyzing a sample in a mass spectrometer comprising the steps
(a) providing a sample holder containing a coating comprising silicone and graphite,
(b) applying the sample onto the sample holder and
(c) performing a mass spectrometry analysis of the sample.

8. The method according to claim 7 further comprsing a step (b1) washing the sample holder after application of the sample thereto to remove contaminations from the sample.

9. A method according to claim 8, wherein the washing step b1, salt contaminations are removed.

10. The method according to claim 7, wherein the mass spectrometry analysis comprises a laser desorption step.

11. Use of a mixture comprsing silicone and graphite in mass spectrometric analysis.

12. Use according to claim 6, wherein the mixture comprises 1 parts by weight of graphite: 100 parts by weight silicone to 70 parts by weight of graphite: 100 parts by weight silicone.

13. Use according to claim 6, wherein the mixture is provided in a thickness of from 0,01 to 1 mm.
